(19) United States
(12) Patent Application Publication
(10) Pub. No.: US 2016/0117491 A1
(43) Pub. Date: Apr. 28, 2016

(54) ELECTRONIC DEVICE AND METHOD FOR VERIFYING USER IDENTIFICATION

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventor: YONG-ZHAO HUANG, Wuhan (CN)

(21) Appl. No.: 14/692,383

(22) Filed: Apr. 21, 2015

(30) Foreign Application Priority Data
Oct. 27, 2014 (CN) 201410580930.9

(51) Int. Cl. G06F 21/32; G06K 9/00

(52) U.S. Cl. CPC G06F 21/32; G06K 9/00617

(57) ABSTRACT

A user verification method executed in an electronic device stores iris information of a user in a storage device of the electronic device. In response to a user request to access the electronic device, iris information of the user is captured. The captured iris information is compared with the stored iris information. If the captured iris information matches the stored iris information, the user is allowed to access the electronic device.

### CROSS-REFERENCE TO RELATED APPLICATIONS

This application claims priority to Chinese Patent Application No. 201410580930.9 filed on Oct. 27, 2014, the contents of which are incorporated by reference herein.

### FIELD

The subject matter herein generally relates to access control mechanisms, and particularly to an electronic device and a method for verifying user identification.

### BACKGROUND

User passwords are widely used to protect information in electronic devices such as mobile phones. A user is required to input a password before accessing an electronic device. However, most passwords consist of numbers and letters, which can be repeated by other people.

### BRIEF DESCRIPTION OF THE DRAWINGS

Implementations of the present technology will now be described, by way of example only, with reference to the attached figures.

FIG. 1 is a block diagram of one example embodiment of a hardware environment for executing a user verification system.

FIG. 2 is a block diagram of one example embodiment of function modules of the user verification system in FIG. 1.

FIG. 3 is a flowchart of one example embodiment of a user verification method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

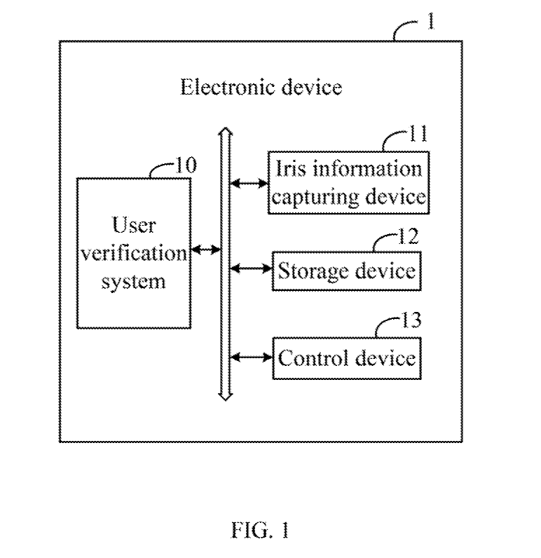

FIG. 1 is a block diagram of one example embodiment of a hardware environment for executing a user verification system 10. The user verification system 10 is installed in and run by an electronic device 1. The electronic device 1 can be a mobile phone, a personal computer, or a server. The electronic device 1 can include an iris information capturing device 11, a storage device 12, and at least one control device 13.

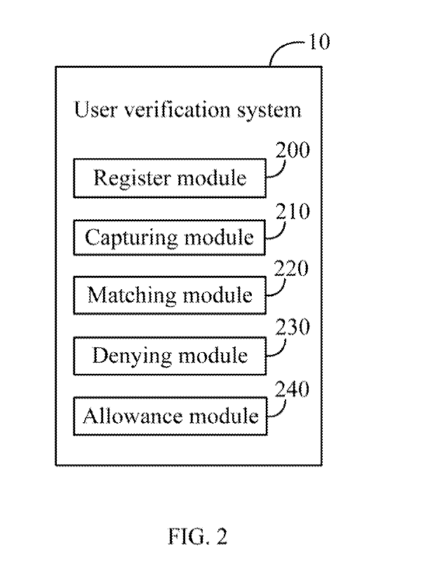

The user verification system 10 can include a plurality of function modules (shown in FIG. 2) that store iris information of a user in the storage device 12 and allow/deny the user access to the electronic device 1 according to the stored iris information.

The iris information capturing device 11 is configured to capture iris information of the user. The iris information capturing device 11 can capture images of an iris of the user, and analyze the iris image to obtain the iris information of the user. The iris information includes visible characteristics of the iris.

The storage device 12 can include some type(s) of non-transitory computer-readable storage medium such as, for example, a hard disk drive, a compact disc, a digital video disc, or a tape drive. The storage device 12 stores the computerized codes of the function modules of the user verification system 10.

The control device 13 can be a processor, a microprocessor, an application-specific integrated circuit (ASIC), or a field programmable gate array (FPGA), for example. The control device 13 can execute computerized codes of the function modules of the user verification system 10 to realize the functions of the electronic device 1.

FIG. 2 is a block diagram of one embodiment of function modules of the user verification system 10. The function modules can include, but are not limited to, a register module 200, a capturing module 210, a matching module 220, a denying module 230, and an allowance module 240. The function modules 200-240 can include computerized codes in the form of one or more programs, which provide at least the functions of the user verification system 10.

The register module 200 is configured to store iris information of a user in the storage device 12. In one embodiment, the register module 200 further generates an encryption key based on the stored iris information, and stores the encryption key into the storage device 12.

The capturing module 210 is configured to receive a user request to access the electronic device 1, and capture iris information of the user using the iris information capturing device 11. In one embodiment, the user presses a specific button on a screen of the electronic device 1 to input the user request. Upon receipt of the user request, the capturing module 210 prompts the user to use the iris information capturing device 11 to input the iris information.

The matching module 220 is configured to read the stored iris information of the user from the storage device 12, compare the captured iris information with the stored iris information, and determine whether the captured iris information matches the stored iris information. In one embodiment, the matching module 220 calculates a similarity between the captured iris information and the stored iris information, and determines whether the captured iris information matches the stored iris information according to the similarity. For example, if the similarity is greater than a predetermined value (e.g., 0.9), the captured iris information is determined to match the stored iris information. A similarity between the stored iris information and the captured iris information indicates a degree of similarity between the stored iris information and the captured iris information. If the storage device 12 stores the stored iris information of more than one user, the matching module 220 calculates a similarity between the captured iris information and the stored iris information of each user, and determines whether the captured iris information matches the stored iris information of any user according to the similarity.

The denying module 230 is configured to deny the user to access the electronic device 1, and to inform the user of a verification failure if the captured iris information does not match the stored iris information. For example, the denying module 230 maintains the locked state of the electronic device 1, and issues a voice message “Verification failed. Please try again.” Depending on the embodiment, the denying module 230 can determine whether a number of sequential verification failures is greater than a predetermined number (e.g., three). If the number of sequential verification failures is greater than the predetermined number, the denying module 230 can prohibit the user from attempting further verifications within a predetermined period of time (e.g., an hour).

The allowance module 240 is configured to allow the user to access the electronic device 1 if the captured iris information matches the stored iris information. In one embodiment, the register module 200 generates an encryption key based on the stored iris information, and stores the encryption key into the storage device 12. The allowance module 240 retrieves the encryption key from the storage device 12, and unlocks the electronic device 1 using the encryption key. The user in such a situation is allowed access to the electronic device.

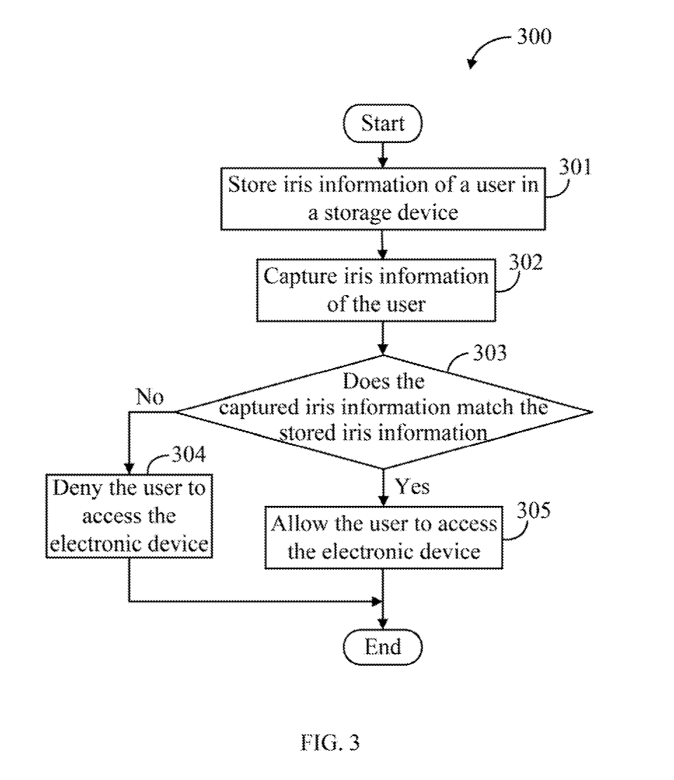

FIG. 3 is a flowchart of one example embodiment of a user verification method. In the embodiment, the method is performed by execution of computer-readable software program codes or instructions by a control device, such as at least one processor of an electronic device. The electronic device includes an iris information capturing device.

Referring to FIG. 3, a flowchart is presented in accordance with an example embodiment. The method 300 is provided by way of example, as there are a variety of ways to carry out the method. The method 300 described below can be carried out using the configurations illustrated in FIGS. 1-2, for example, and various elements of these figures are referenced in explaining method 300. Each block shown in FIG. 3 represents one or more processes, methods, or subroutines, carried out in the method 300. Furthermore, the illustrated order of blocks is illustrative only and the order of the blocks can be changed. Additional blocks can be added or fewer blocks may be utilized without departing from this disclosure. The method 300 can begin at block 301.

At block 301, a register module stores iris information of a user in a storage device of the electronic device. In one embodiment, the register module further generates an encryption key based on the stored iris information, and stores the encryption key into the storage device.

At block 302, a capturing module receives a user request to access the electronic device. In response to the user request, the capturing module captures captured iris information of the user using the iris information capturing device. In one embodiment, the user presses a specific button on a screen of the electronic device to input the user request. Upon receipt of the user request, the capturing module prompts the user to use the iris information capturing device to input the captured iris information.

At block 303, a matching module reads the stored iris information of the user from the storage device, compares the captured iris information with the stored iris information, and determines whether the captured iris information matches the stored iris information. In one embodiment, the matching module calculates a similarity between the captured iris information and the stored iris information, and determines whether the captured iris information matches the stored iris information according to the similarity. For example, if the similarity is greater than a predetermined value (e.g., 0.9), the captured iris information is determined to match the stored iris information. A similarity between the stored iris information and the captured iris information indicates a similar degree between the stored iris information and the captured iris information. If the storage device stores the stored iris information of more than one user, the matching module calculates a similarity between the captured iris information and the stored iris information of each user, and determines whether the captured iris information matches the stored iris information of any user according to the similarity.

If the captured iris information does not match the stored iris information, at block 304, a denying module denies the user to access the electronic device, and informs the user of a verification failure. For example, the denying module maintains the electronic device in a locked state, and issues a voice message “Verification failed. Please try again.” Depending on the embodiment, the denying module can determine whether a number of sequential verification failures is greater than a predetermined number (e.g., three). If the number of sequential verification failures is greater than the predetermined number, the denying module can prohibit the user from attempting further user verifications within a predetermined period of time (e.g., an hour).

If the captured iris information matches the stored iris information, at block 305, an allowance module allows the user to access the electronic device. In one embodiment, the register module generates an encryption key based on the stored iris information, and stores the encryption key into the storage device. The allowance module retrieves the encryption key from the storage device, and unlocks the electronic device using the encryption key. Such a user is thus allowed access to the electronic device.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

What is claimed is:

1. A user verification method for an electronic device, the method comprising:
storing iris information of a user in a storage device of the electronic device;
capturing iris information of the user in response to a user request to access the electronic device;
determining that the captured iris information matches the stored iris information; and
enabling access to the electronic device upon such determination.

2. The method according to claim 1, further comprising:
determining that the captured iris information does not match the stored iris information; and
denying access to the electronic device upon such determination.

3. The method according to claim 1, further comprising:
prohibiting the user from attempting further user verifications within a predetermined period of time upon condition that a number of sequential verification failures is greater than a predetermined number.

4. The method according to claim 1, further comprising:
generating an encryption key based on the stored iris information, and storing the encryption key into the storage device.

5. The method according to claim 4, further comprising:
retrieving the encryption key from the storage device, and unlocking the electronic device using the encryption key.

6. An electronic device comprising:
a control device; and
a storage device storing one or more programs which when executed by the control device, causes the control device to perform operations comprising:
storing iris information of a user in the storage device;
capturing iris information of the user in response to a user request to access the electronic device;
determining that the captured iris information matches the stored iris information; and
enabling access to the electronic device upon such determination.

7. The electronic device according to claim 6, wherein the operations further comprise:
determining that the captured iris information does not match the stored iris information; and
denying access to the electronic device upon such determination.

8. The electronic device according to claim 6, wherein the operations further comprise:
prohibiting attempting further user verifications within a predetermined period of time in a predetermined time upon condition that a number of sequential verification failures is greater than a predetermined number.

9. The electronic device according to claim 6, wherein the operations further comprise:
generating an encryption key based on the stored iris information, and storing the encryption key into the storage device.

10. The electronic device according to claim 9, wherein the operations further comprise:
retrieving the encryption key from the storage device, and unlocking the electronic device using the encryption key.

11. A non-transitory storage medium having stored thereon instructions that, when executed by a control device of an electronic device, causes the control device to perform a user verification method, the method comprising:
storing iris information of a user in a storage device of the electronic device;
capturing iris information of the user in response to a user request to access the electronic device;
determining that the captured iris information matches the stored iris information; and
enabling access to the electronic device upon such determination.

12. The non-transitory storage medium according to claim 11, wherein the method further comprises:
determining that the captured iris information does not match the stored iris information; and
denying access to the electronic device upon such determination.

13. The non-transitory storage medium according to claim 11, wherein the method further comprises:
prohibiting the user from attempting further user verifications within a predetermined period of time upon condition that a number of sequential verification failures is greater than a predetermined number.

14. The non-transitory storage medium according to claim 11, wherein the method further comprises:
generating an encryption key based on the stored iris information, and storing the encryption key into the storage device.

15. The non-transitory storage medium according to claim 14, wherein the method further comprises:
retrieving the encryption key from the storage device, and unlocking the electronic device using the encryption key.
